(19) United States
(12) Patent Application Publication
(10) Pub. No.: US 2005/0073708 A1
(43) Pub. Date: Apr. 7, 2005

(54) Method of reporting print option in printing system

(76) Inventors: Myoung-jin Oh, Suwon-si (KR); Young-soo Han, Suwon-si (KR)

Correspondence Address: STANZIONE & KIM, LLP, 1740 N STREET, N.W., FIRST FLOOR, WASHINGTON, DC, 20036, US

(21) Appl. No.: 10/934,487

(22) Filed: Sep. 7, 2004

(30) Foreign Application Priority Data
Oct. 1, 2003 (KR) 2003-68212
Dec. 3, 2003 (KR) 2003-87253

(51) Int. Cl. G06F 15/00

(52) U.S. Cl. 358/1.13

(57) ABSTRACT

A method of reporting print options in a printing system, which includes an image forming apparatus to execute printing operation, a display apparatus, a storing medium, and a host computer to transmit print data to the image forming apparatus includes changing one or more print options in the printing system, in which the changing of print options is performed by an user, and selecting help information corresponding to the print options changed by the user from help information previously stored in the storing medium and outputting the selected help information through the image forming apparatus using the host computer when the printing operation is performed after the print options have been changed. According to this method, whenever a user performs the printing operation after changing one or more printing options of a printer, the help information corresponding to the changed printing options is presented through a monitor or a printer. Thus, the user can easily confirm which print options are used in a printed matter outputted through the image forming apparatus.

### CROSS-REFERENCE TO RELATED APPLICATIONS

This application claims the benefit of Korean Patent Application Nos. 2003-68212, filed on Oct. 1, 2003, and 2003-87253, filed on Dec. 3, 2003, in the Korean Intellectual Property Office, the disclosure of which is incorporated herein by reference.

### BACKGROUND OF THE INVENTION

1. Field of the Invention

The present general inventive concept relates to a printing system, and in particular, to a method of reporting print options in a printing system, which enables a user to be easily informed of print options pre-set for an image forming apparatus in such a manner of informing the user of help information either by printing a changed print option through an image forming apparatus or by displaying the help information concerning the changed print option on a screen when the user performs a printing operation after changing one or more print options, and which enables the user to easily determine which one is incorrect among the print options previously set by the user if a printed matter is erroneously outputted.

2. Description of the Related Art

FIG. 1 is a view illustrating an example of an ordinary printing system. Referring to FIG. 1, the printing system includes a host computer 100, a printer 300, and a cable 200 for interconnecting the host computer 100 and the printer 300. Typically, the host computer 100 comprises a monitor 110, an input/output device such as a keyboard 140, and a main body 150 capable of executing an operating system and an application program. In addition, the main body 150 is provided with a hard disc drive (not shown) for storing the operating system and the application program.

FIG. 2 is a view schematically illustrating a process of performing a printing operation in the printing system of FIG. 1. Referring to FIG. 2, the hard disc drive (not shown) is provided with an application program (APP) 101 driven in an operating system (e.g., an operating system of Window series), a graphic device interface (GDI) 102, a driver 103, and a spooler 104.

The APP 101 is a program that enables documentation like a word processor. Among programs for this purpose, “Office” developed and sold by Microsoft Corporation is the most typical program. Beyond this, the program, “StarOffice” may also be employed. Such a documentation program renders characters and graphics typed by a user to correspond to functions for expressing characters, graphics and lines, which functions are provided in an interface program, i.e., GDI 102 installed in the Windows operating system. The GDI 102 is one of interface programs available from Microsoft Corporation. The GDI 102 allows various application programs driven on the basis of an operating system (e.g., Windows 2000) to execute desired functions through common graphic functions provided in the GDI 102. For example, when it is desired to output straight line, curved line, polygon, text, and/or bit map images, or the like, the GDI 102 provides a function capable of reproducing the figures and characters enumerated above on a screen or a printer.

The driver 103 serves to control a printer in response to a call from the APP 101, when it is desired to print out a document drawn up in the APP through the printer. The spooler 104 is one of programs provided by the operating system and serves to buffer print data outputted from the driver 103 for a predetermined length of time and then to apply it to the printer 300.

The spooler 104 detects the progress of printing operation as occasion calls and buffers the print data so that the printer data is transmitted by a capacity capable of being received by the printer, whereby the printer 300 can stably perform the printing operation.

In general, users of an image forming apparatus, such as a facsimile, need to learn how to use such an apparatus through a user's manual or help information about the image forming apparatus. Most of the users seldom read the user's manual or do not fully understand technical terminologies for controlling the image forming apparatus. As a result, the users tend to use the image forming apparatus, such as a printer, according to basically pre-set values, which have been already set in the image forming apparatus, because they do not fully understand functions provided in the image forming apparatus when they use the image forming apparatus.

Meanwhile, the users tend to use the image forming apparatus, such as the printer, without changing one or more options if there is no problem in using the one or more print options of the image forming apparatus. For example, if a user temporarily sets a resolution of the printer, whose normal resolution is 600 dpi, to 1200 dpi or more for executing high quality printing, the user frequently forgets the fact that a consuming rate of toner becomes increased due to the high resolution set by the user for the high quality printing. Consequently, the user does not recognize the fact that the resolution has been set to a high value until all toner provided in the printer is prematurely consumed. In order to solve this problem, there has been known a conventional printing system that displays a description concerning changed print options on a monitor when one or more print options of an image forming apparatus have been changed. However, such a solution is not so helpful for an ordinary user who seldom remembers print options set by the user.

### SUMMARY OF THE INVENTION

In order to solve the above-mentioned and/or other problems, it is an aspect of the present general inventive concept to provide a method of reporting print options in a printing system, which enables a user to easily recognize information concerning changed print options when a printing operation is executed after one or more print options in the printing system have been changed by the user.

Additional aspects and advantages of the present general inventive concept will be set forth in part in the description which follows and, in part, will be obvious from the description, or may be learned by practice of the general inventive concept.

In order to achieve the above and/or other aspects of the present general inventive concept, there is provided a method of reporting print options in a printing system, which include an image forming apparatus to execute a printing operation, a display apparatus, a storing medium, and a host computer to transmit print data to the image forming apparatus, wherein the method includes changing one or more print options in the printing system, in which the changing of the print options is performed by an user, and selecting first help information corresponding to the print options changed by the user from second help information previously stored in the storing medium, and outputting the selected help information through the image forming apparatus using the host computer when the printing operation is performed after the print options have been changed.

In an aspect of the present general inventive concept, the help information may contain a description concerning the print options changed by the user from those initially set in the host computer.

In another aspect of the present general inventive concept, the help information may contain a difference between the print options previously set in the host computer and those set by the user.

In another aspect of the present general inventive concept, the help information may contain a description concerning output characteristics of a printed matter outputted from the image forming apparatus when the print options have been changed.

In another aspect of the present general inventive concept, the outputting of the selected help information includes outputting report data in advance prior to performing the printing operation for the print data.

In order to achieve the above and/or other aspects of the present general inventive concept, there is also provided a method of reporting print options in a printing system, which includes an image forming apparatus to execute printing operation, a display apparatus, a storing medium, and a host computer to transmit print data to the image forming apparatus, wherein the method includes changing one or more print options in the printing system, in which the changing of the print options is preformed by a user, and selecting first help information corresponding to the changed print options from second help information previously stored in the storing medium, and outputting the selected help information through the display apparatus through the host computer when the printing operation is performed after the one or more print options have been changed.

In an aspect of the present general inventive concept, the outputting of the selected help information through the display apparatus includes outputting the selected help information when the user performs the printing operation after setting one or more desired print options in a print option menu.

In another aspect of present general inventive concept, the changing of the print options includes displaying a print option menu to change the print options on the display apparatus, setting the one or more print options in the print option menu, in which the setting of the print options is executed by the user, and recording the set result in a driver to drive the image forming apparatus.

In another aspect of the present general inventive concept, the outputting of the selected help information includes outputting report data in advance prior to performing the printing operation of printing the print data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view conceptually illustrating a general printing system;

FIG. 2 is a view schematically illustrating a process, during which a printing operation is executed in the printing system shown in FIG. 1;

FIGS. 3A to 3D are views illustrating a method of reporting print options in a printing system according to an embodiment of the present general inventive concept;

FIG. 4 is a flowchart illustrating a method of reporting print options in a printing system according to another embodiment of the present general inventive concept; and

FIG. 5 is a flowchart illustrating a method of reporting print options in a printing system according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

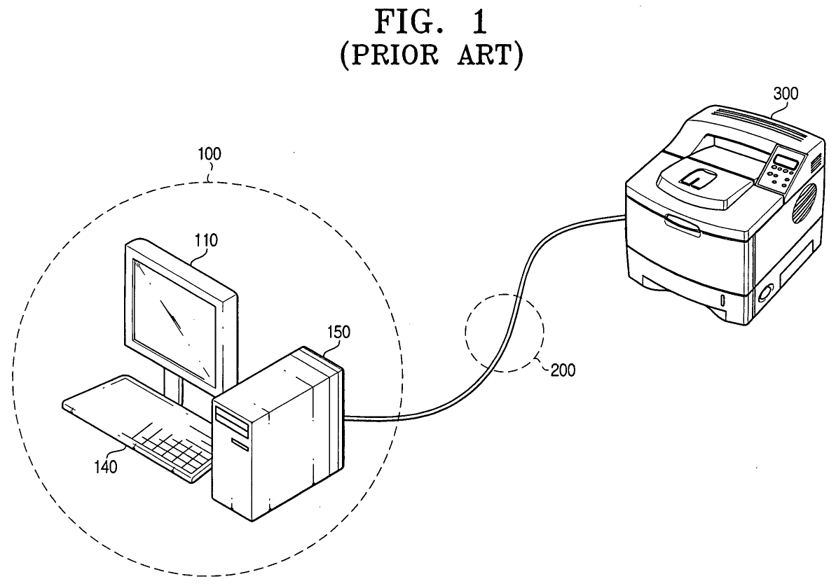

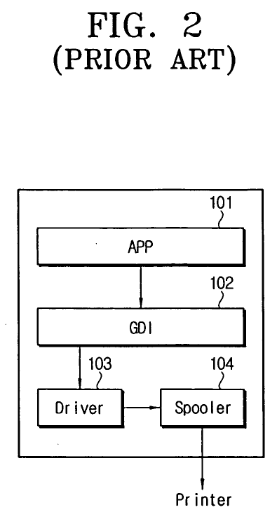

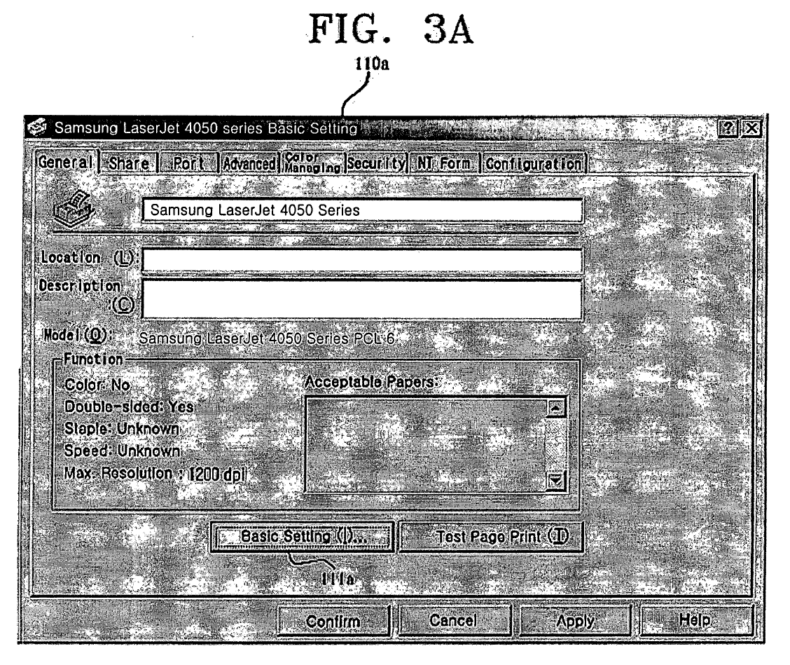

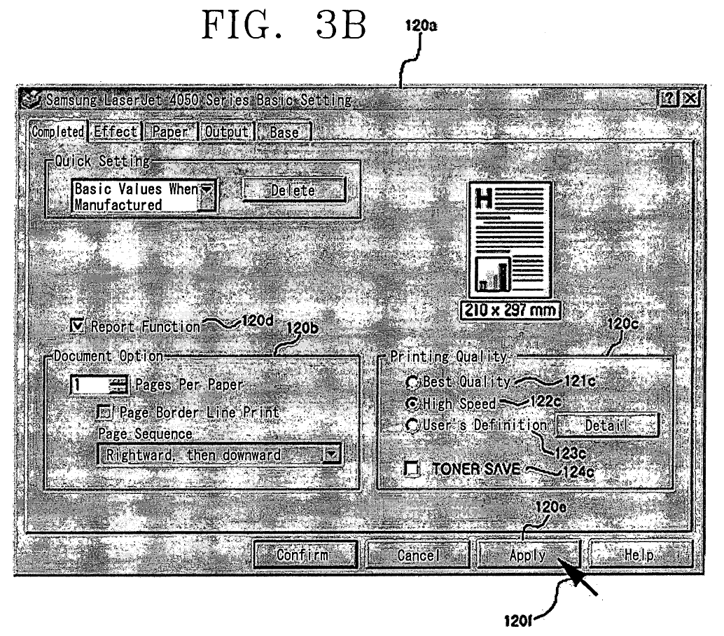

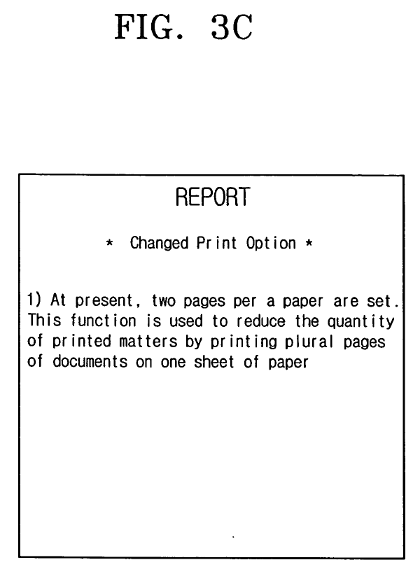

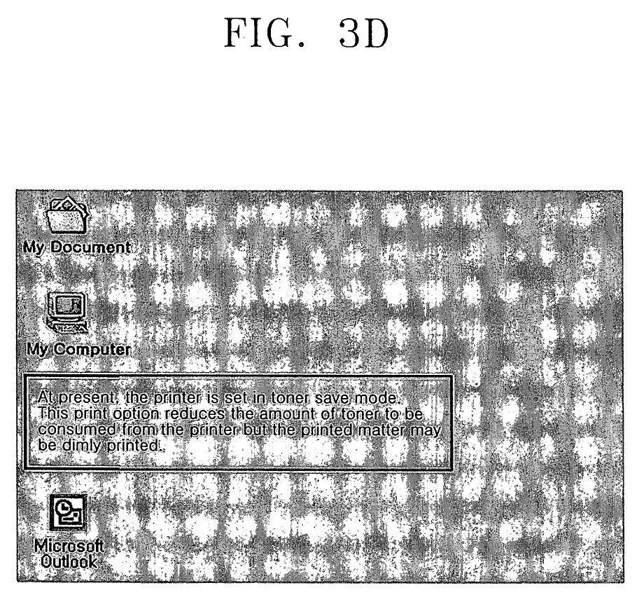

FIGS. 3A to 3D are views illustrating a method of reporting print options in a printing system. A printing system and a printing operation of the printing system as illustrated in FIGS. 1 and 2, respectively, can be adapted for use in performing the method of FIGS. 3A and 3D.

Firstly, FIG. 3A illustrates a menu screen 110a displayed as a result of executing a driver setting program installed in a host computer 100. As a result of executing the driver setting program, the menu screen 101a as shown in FIG. 3A can be displayed on a monitor 110. If a user wishes to change one or more print options for the printer, the user can press a setting key 111a in the displayed menu screen 110a.

FIG. 3B illustrates a second menu screen 120a displayed on the monitor 110 when the user presses the setting key 111a in the menu screen 110a shown in FIG. 3A.

The menu screen 120a shown in FIG. 3B shows various submenus to set various print options for print data printed from the printer 300. Reference symbol 120b indicates a document option to set the number of pages to be printed per unit paper (e.g., A4, legal, letter paper), reference symbol 120c indicates a printing quality setting option, reference symbol 120d indicates a help displaying option to display help information concerning one or more selected options on the monitor 110 when the user selects this option, reference symbol 120e indicates an application key to reflect the print options selected by the user to the driver, and reference symbol 120f indicates a cursor. In addition, reference symbols 121c, 122c and 123c indicate options to set printing quality of a printed matter outputted from the printer in accordance with “best quality,” “high speed” and “user's definition,” respectively, and reference symbol 124c indicates a toner setting option to save toner if the printer 300 is a laser printer.

FIG. 3C illustrates an example of help information printed by a printer 300 (FIG. 1) to correspond to the selected document option 120b, when the printing operation is performed after the user has selected the document option 120b to set the number of pages per unit paper in the menu screen 120a shown in FIG. 3B. Such help information can be provided in a hard disc drive (not shown) installed in the host computer 100, and can be installed when the driver of the printer 300 is installed in the hard disc drive. As shown in FIG. 3B, if the user sets the number of pages per unit paper in the document option 120b and then renders a printing command for a predetermined file, the printer 300 can report one or more changed print options to the user by printing out the help information as shown in FIG. 3C prior to printing out the document file. In an aspect of the present general inventive concept the print options set in the host computer 100 when the driver of the printer 300 is initially installed, can be compared with the one or more changed print options changed by the user, so that the help information reported to the user can contain all of the one or more changed printed options changed from the initially installed print options by the user according to the result of comparison.

On the other hand, the help information reported to the user may report only a difference between the print options set by the user and the print options changed by the user after setting the print options in reference to the print options previously set by the user. As a result, the user, who newly sets one or more print options in an image forming apparatus, can recognize values of the print options set by the user in such a manner of reading the help information outputted from the image forming apparatus when the print data is printed out.

Such help information can be included either in an application program to control the printer 300 or in a driver developed to drive the printer 300. And, an operation of displaying such help information on a monitor 110 can be implemented by incorporating an application program to convert proper help information into the print data and to transmit the print data to the printer 300 in response to the print options when the user sets the print options into the driver or the application program to control the printer using a menu screen, such as the menu screen 120a or 120b, as described above.

FIG. 3D shows the help information displayed on a monitor when the user selects the toner setting option (TONER SAVE) 124c in the print quality setting option 120c shown in FIG. 3B. In addition to the method of printing the help information through the printer 300, another method of reporting the print options in a printing system is also capable of reporting the help information to the user in such a manner of displaying the help information on the monitor 110 when the user renders the printing command to print the document file generated by the application program, such as StarOffice. For example, when the application program is executed to perform the printing operation after the user selects the toner setting option (TONER SAVE) 124c and presses the application key 120e, the help information as shown in FIG. 3D can be displayed on the monitor 110.

Therefore, the user can be easily informed of the characteristics of the printed matter printed out from the printer 300 on the basis of the help information displayed on the monitor 110. The user can also be informed of the print options set by the user each time when the printer 300 performs the printing operation.

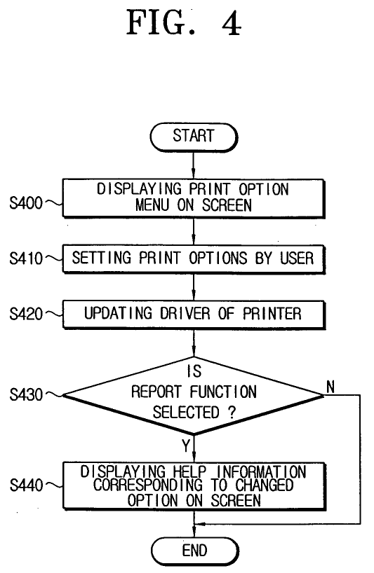

FIG. 4 shows a flowchart illustrating a method of setting a print option in a printing system according to another embodiment of the present general inventive concept.

Referring to FIGS. 1 through 4, if the user wishes to control one or more print options of the printer 300, the user clicks a driver setting program provided by an operating system, and then, the menu screen 110a as shown in FIG. 3A, is displayed on the monitor 110 (S400). Next, the user presses a setting key 111a in the menu screen 110a and thus enters a menu screen 120a to set one or more print options. After entering the menu screen 120a, the user moves a curser 120f to select one or more needed options (S410). The options selected by the user may include a document option (120b) to set the number of pages to be printed per unit paper, a printing quality setting option 120c, a toner setting option (TONER SAVE) 120c to control a consuming rate of toner, and the like. In addition to the selected options, there may be various print options provided by a provider who develops and sells the printer 300.

Next, the host computer 100 can reflect the print options selected by the user to update a driver (S420), and can confirm whether or not the user has selected a report option 120d (S430). Finally, if the report option 120d were not selected, the host computer 100 may not output help information through the printer, and if the report option 120d were selected, the host computer 100 can output the help information onto the screen 110 in advance prior to performing printing operation instructed by the user (S440). The outputted help information can describe the characteristics of the printed matter outputted according to the print options changed by the user on the basis of comparison between the changed print options and the print options stored in the driver. On the other hand, it is also possible that the print options set when the driver is initially installed into the host computer 100, and the print options changed by the user thereafter are compared with each other, so that the help information concerning all of the changed options 110 is displayed on the monitor 110. Although the help information is displayed on the monitor as described above, it is also possible to display the help information through a panel operation section (not shown) provided in the printer 300. The panel operation section may include a menu key (not shown) to be used by the user to control the printer 300, a direction key (not shown) and a liquid crystal display (LCD) (not shown) of a predetermined size to display the status of the printer 300.

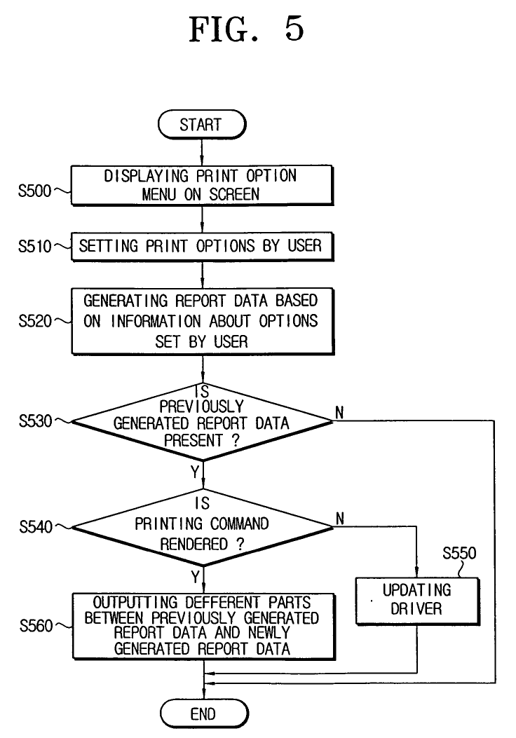

FIG. 5 shows a flowchart illustrating a method of setting print options in a printing system according to another embodiment of the present general inventive concept.

Referring to FIGS. 1-5, the embodiment shown in FIG. 5 employs a method of providing a user with information concerning print options changed by the user by printing the information on a paper through a printer 300, instead of outputting the changed print options through a monitor 110. Firstly, the user can execute a driver setting program to control printer options of the printer 300 so that a menu screen 110a shown in FIG. 3A is displayed on the monitor 110 (S500). Next, the user can press a setting key 111a in the menu screen 110a to enter a menu screen 200 to set one or more print options, and can select one or more desired options among a document option 120b, a printing quality setting option 120c, and a toner setting option (TONER SAVE) 124c to control a consuming rate of toner to be used (S510). Next, a host computer 100 can generate report data in a file format to describe the print options selected by the user (S520). In an aspect of the present general inventive concept, the report data can be generated each time when the user changes one or more print options. Next, the host computer 100 can determine whether or not previously generated report data is present (S530). If the previously generated report data is present, the host computer 100 can compare the newly generated report data with the previously generated report data to find a difference between them (S540). At this time, if there is any difference between the previously generated report data and the newly generated report data, the host computer 100 can store the difference as a log file. Next, when the user renders a command of a printing operation for a document prepared by the user, the host computer 100 can output the log file in advance (S560) prior to printing the document, thereby allowing the user to recognize the changed print options. If no printing command is rendered, the host computer 100 can update the driver to control the printer 300 (S550). In another aspect of the present general inventive concept, the help information reported to the user may contain only the difference between the previous print options set by the user and the print options set thereafter. On the other hand, the help information may report all the print options changed from those set in the host computer 100 when the driver of the printer 300 is initially installed in the host computer 100, by comparing all the initially set print options and the changed print options. Using this process, the user can recognize all the differences between the print options initially installed in the host computer 100 and the printed options set by the user.

As described above, according to the present invention, whenever a user who lacks technical information performs a printing operation after changing one or more printing options of a printer, help information corresponding to the changed printing options can be presented through a monitor or a printer. Thus, the user can easily confirm which print options are used in a printed matter outputted through an image forming apparatus. In addition, if the printed matter is printed by an erroneous print option, the user can easily find it.

While the preferred embodiments of the present invention have been shown and described with reference to the preferred embodiments thereof, the present invention is not limited to the embodiments. It will be understood that various modifications and changes can be made by those skilled in the art without departing from the spirit and scope of the invention as defined by the appended claims. Therefore, it shall be considered that such modifications, changes and equivalents thereof are all included within the scope of the present invention.

1. A method of reporting print options in a printing system, which comprises an image forming apparatus to execute a printing operation, a display apparatus, a storing medium, and a host computer to transmit print data to the image forming apparatus, the method comprising:
changing one or more print options in a printing system; and
selecting first help information corresponding to the one or more print options changed by the user from second help information previously stored in a storing medium, and outputting the selected first help information through an image forming apparatus using a host computer, when a printing operation is performed after the one or more print options have been changed.

2. The method according to claim 1, wherein the selected first help information contains a description concerning the changed one or more print options changed by a user from the one or more print options initially set in the host computer.

3. The method according to claim 1, wherein the selected first help information contains a difference between the one or more print options previously set in the host computer and the one or more print options set by a user.

4. The method according to claim 1, wherein the selected first help information contains a description concerning output characteristics of a printed matter outputted from the image forming apparatus when the one or more print options have been changed.

5. The method according to claim 1, wherein the outputting of the selected first help information comprises outputting report data in advance prior to performing the printing operation of printing the print data in the image forming apparatus.

6. A method of reporting print options in a printing system, which comprises an image forming apparatus to execute a printing operation, a display apparatus, a storing medium, and a host computer to transmit print data to the image forming apparatus, the method comprising:
changing one or more print options in a printing system; and
selecting first help information corresponding to the changed one or more print options from second help information previously stored in the storing medium and outputting the selected first help information through the display apparatus using a host computer when a printing operation is performed after the one or more print options have been changed.

7. The method according to claim 6, wherein the outputting of the selected first help information through the display apparatus comprises outputting the selected first help information when the printing operation is performed after the one or more print options are set in a print option menu.

8. The method according to claim 6, wherein the changing of the print options comprises:
displaying a print option menu to change the one or more print options on the display apparatus;
setting the one or more print options in the print option menu; and
recording the set result in a driver to drive the image forming apparatus.

9. The method according to claim 6, wherein the outputting of the selected first help information comprises outputting report data in advance prior to performing the printing operation of printing the print data.

10. The method according to claim 6, wherein the selected first help information contains a description concerning the one or more print options changed by a user from the one or more print options initially set in the host computer.

11. The method according to claim 6, wherein the selected first help information contains a difference between the one or more print options previously set in the host computer and the one or more print options set by a user.

12. The method according to claim 6, wherein the selected first help information contains a description concerning output characteristics of a printed matter outputted from the image forming apparatus when the one or more print options have been changed.

13. The method according to claim 6, wherein the changing of the one or more print options comprises allowing a user to change and set the one or more print options, and the outputting of the selected first help information comprises outputting the change of the one or more print options.

14. A method of changing one or more print options in a printing system, the method comprising:
changing a first print option to a second print option; and
generating help information about the changing of the first print option to the second print option when a printing operation is performed after the first print operation has been changed to the second print option.

15. The method according to claim 14, wherein the first print option is one of a previously changed print option and a preset print option.

16. The method according to claim 14, wherein the changing of the first print option to the second print option comprises displaying a menu screen on a display so that the first print option is changed to the second print option through the menu screen, and the help information corresponding to the first option and the second information is displayed on the display when the printing operation is performed after the first print operation has been changed to the second print option.

17. The method according to claim 14, wherein the changing of the first print option to the second print option comprises displaying a menu screen of a printer so that the first print option is changed to the second print option through the menu screen, and the help information corresponding to the first option and the second information is displayed on the printer when the printing operation is performed after the first print operation has been changed to the second print option.

18. The method according to claim 14, further comprising:
generating a command to perform the printing operation to print a document on a sheet of paper in a printer,
wherein the generating of the help information comprises displaying a report relating to the change between the first print option and the second print option.

19. The method according to claim 18, wherein the report comprises information about a characteristic of the printing operation.

20. The method according to claim 14, wherein the generating of the help information comprises preventing the printing operation from being performed until the generated help information is displayed.

21. The method according to claim 14, wherein the generating of the help information comprises
determining a difference between the first print option and the second print option; and
selectively generating the help information according to the difference.

22. The method according to claim 14, wherein the generating of the help information comprises:
determining whether a report operation is selected; and
selectively generating the help information according to the report operation.
